(19) United States
(12) Patent Application Publication
(10) Pub. No.: US 2025/0315076 A1
(43) Pub. Date: Oct. 9, 2025

(54) CHANNELLESS CLOCK TREE SYNTHESIS METHOD

(71) Applicant: MEDIATEK INC., Hsin-Chu (TW)

(72) Inventors: Kai-Hua Hsu, Hsinchu City (TW); Cheng-Hsun Liu, Hsinchu City (TW); Chun-Jung Li, Hsinchu City (TW); Chen-Hsing Lo, Hsinchu City (TW); Wei-Liang Ying, Hsinchu City (TW)

(73) Assignee: MEDIATEK INC., Hsin-Chu (TW)

(21) Appl. No.: 18/629,932

(22) Filed: Apr. 8, 2024

(51) Int. Cl. G06F 1/04

(52) U.S. Cl. CPC G06F 1/04

(57) ABSTRACT

A clock tree synthesis method comprises obtaining information of a source node and information of N leaf nodes, N being a positive integer greater than 1, performing a Steiner tree algorithm according to the information of the source node and the information of the N leaf nodes to determine information of a set of branch nodes, and creating a clock feedthrough according to the information of the source node, the information of the N leaf nodes, and the information of the set of branch nodes.

### BACKGROUND

The invention relates to clock tree synthesis, and in particular, to a channelless clock tree synthesis method.

A clock tree is a clock distribution network in an integrated circuit (IC) design. An integrated circuit design may include multiple clock trees. A clock tree includes the clocking circuitry from a clock source to multiple components. Clock tree synthesis (CTS) is a technique used to balance the clock skew and reduce clock latency.

The prior art reserves channels for clock path, the clock path passing through channels along the edge of the partitions. Since the channels area is reserved, the chip area is increased. The prior art plans the clock path and evaluates clock quality after finishing the chip floorplan, and it may increase clock variation if channel plan is bad.

### SUMMARY

An embodiment of the present invention discloses a clock tree synthesis method, comprising obtaining information of a source node and information of N leaf nodes, N being a positive integer greater than 1; performing a Steiner tree algorithm according to the information of the source node and the information of the N leaf nodes to determine information of a set of branch nodes; and creating a clock feedthrough according to the information of the source node, the information of the N leaf nodes, and the information of the set of branch nodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a flowchart of a clock tree synthesis method according to an embodiment of the present invention.

FIG. 2 shows a flowchart of Step S100 of the clock tree synthesis method in FIG. 1.

FIG. 3 shows a schematic diagram of a layout 3 according to an embodiment of the present invention.

FIG. 4 shows a graph model of a binary clock tree 4 derived by performing the Steiner tree algorithm on the layout 3.

FIG. 5 shows layout diagram of a layout of the binary clock tree in FIG. 4.

FIG. 6 shows a graph model of a binary clock tree according to another embodiment of the present invention.

FIG. 7 shows layout diagram of a pre-balanced binary clock tree according to another embodiment of the present invention.

FIG. 8 shows layout diagram of a post-balanced binary clock tree according to the pre-balanced binary clock tree in FIG. 8.

FIG. 9 shows a computer system for performing a clock tree synthesis method.

### DETAILED DESCRIPTION

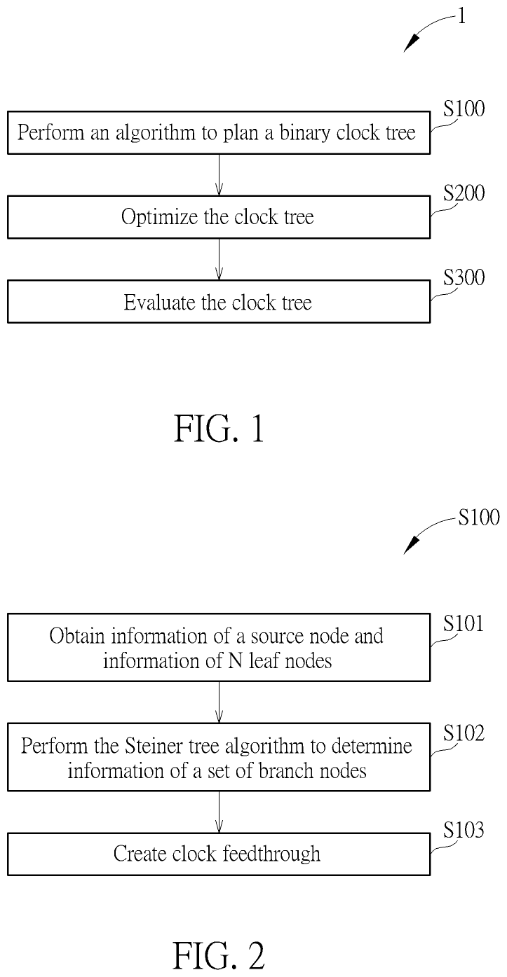

Clock tree synthesis (CTS) is a technique of balancing the clock latency to all clock inputs in integrated circuit (IC) design. The purpose of the clock tree synthesis is to balance clock skew and minimize clock latency. The clock skew is a difference in the arrival times of clock signals at two different components, resulting from a path length difference between two clock paths. Various embodiments of the invention are provided to balance clock skew and minimize clock latency, as will be discussed in the subsequent paragraphs. FIG. 1 shows a flowchart of a clock tree synthesis method 1 according to an embodiment of the present invention. The clock tree synthesis method 1 is used to plan clock paths and evaluate clock paths at an early stage to balance clock skew, minimize clock latency and reduce clock variation. The clock tree synthesis method 1 comprises Steps S100 to S300. Any reasonable step change or adjustment is within the scope of the disclosure. Steps S100 to S300 are explained as follows:
Step S100: Perform an algorithm to plan a binary clock tree;
Step S200: Optimize the clock tree;
Step S300: Evaluate the clock tree.

In Step S100, obtain information of a source node and leaf nodes and perform an algorithm to plan a binary clock tree according to the information of the nodes. The algorithm may be a Steiner tree algorithm. A Steiner Tree is an undirected, weighted graph with a minimum-weight tree that connects a selected set of nodes. In the present invention, the Steiner tree algorithm is used to find the binary clock tree according to the information of the source node and leaf nodes. Clock feedthroughs may be created according to the information of the nodes of the binary clock tree. Clock signals may be routed from the clock source to respective blocks via the clock feedthroughs. Each block may be a partition, a standard cell or a macro.

In Step S200, optimize the binary clock tree after creating the clock feedthrough. Then the blocks may feed back clock information of the clock signals after optimizing the binary clock tree.

In Step S300, the clock information are collected from each of the blocks. Then check the quality of the binary clock tree according to the collected clock information in order to review clock quality at early stage. The quality may be indicated by clock skew and clock latency.

FIG. 2 is a flowchart of Step S100 of the clock tree synthesis method 1 in FIG. 1. The Step S100 comprises Steps S101 to S301. Any reasonable step change or adjustment is within the scope of the disclosure. Steps S101 to S301 are explained as follows:
Step S101: Obtain information of a source node and information of N leaf nodes;
Step S102: Perform the Steiner tree algorithm to determine information of a set of branch nodes;
Step S103: Create clock feedthrough.

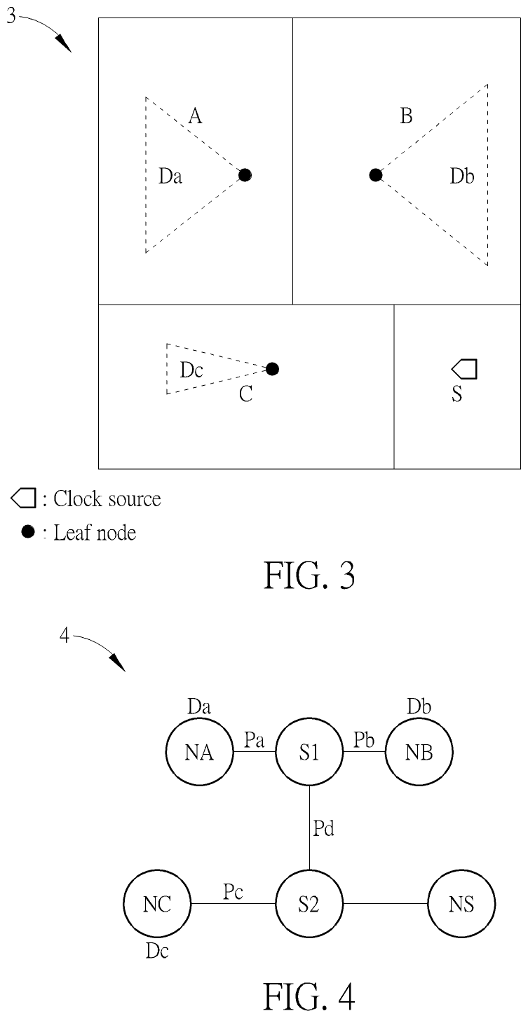

In Step 101, obtain information of a source node and information of N leaf nodes. N is a positive integer greater than 1. The information of the source node comprises a position of the source node, and the information of a leaf node in the N leaf nodes comprises a position and a weight of the leaf node. The weight of the leaf node may be the internal clock latency in the block where the leaf node is located. In one example, N=3, the generation of the binary clock tree may be started with a source node and 3 leaf nodes, as indicated in FIG. 3. FIG. 3 shows a schematic diagram of a layout 3 according to an embodiment of the present invention. The layout 3 comprises a block A, a block B, a block C and a clock source S. The clock source S may include a clock generator such as a phase-locked-loop-based clock generator or a delay locked-loop-based clock generator. The internal clock latency of the block A is Da, the internal clock latency of the block B is Db and the internal clock latency of the block C is Dc. The larger the block size is, the greater the internal clock latency of the block is. For example, if the size of the block B is larger than the size of the block A, the internal clock latency Db of the block B is greater than the internal clock latency Da of the block A. The blocks can be represented as leaf nodes for the Steiner tree algorithm operation in Step 102 as indicated in FIG. 4. The block A can be represented as the leaf node NA, the block B can be represented as the leaf node NB and the block C can be represented as the leaf node NC. The weight of the leaf node NA is the internal clock latency Da, the weight of the leaf node NB is the internal clock latency Db, and the weight of the leaf node NC is the internal clock latency Dc. The clock source can be represented as a source node NS.

In Step 102, perform the Steiner tree algorithm according to the information of the source node and the information of the N leaf nodes to determine information of a set of branch nodes. A branch node in the set of the branch nodes is an additional node connecting two nodes, and the information of the branch node may include a position and a weight. The two nodes may be two leaf nodes, two branch nodes, or one leaf node and one branch node. The weight of the branch node may be equal to a sum of the weight of one of the two nodes and a weight of a connection between the branch node and the one of the two nodes, wherein the weight of the connection is the clock latency on the connection. The position of a branch node may be determined according to the Steiner tree algorithm to balance the latency of a first branch path from the branch node to a first end node and the latency of a second branch path from the branch node to a second end node. The first branch path may pass through a first node of the two nodes or end at the first node (i.e., the first node is the first end node), and the second branch path may pass through a second node of the two nodes or end at the second node (i.e., the second node is the second end node).

The information of the set of branch nodes may be determined by selecting two nodes having the minimum Manhattan distance from all available nodes, and determining a position of a branch node according to the weight of the selected nodes. The Manhattan distance is a sum of a distance between X coordinates of the two nodes and a distance between Y coordinates of the two nodes. For example, to insert a first branch node, two first nodes having the minimum Manhattan distance may be selected from the N leaf nodes, and the position of the first branch node may be determined according to the two first nodes. Similarly, to insert a second branch node, two second nodes having the minimum Manhattan distance may be selected from the remaining leaf nodes and the first branch node, and the position of the second branch node may be determined according to the two second nodes. Repeat the above process until every leaf nodes and the branch nodes are connected together to form a binary clock tree. Then connect the source node to a last branch node to form the binary clock tree such as one illustrated in FIG. 4.

FIG. 4 shows a graph model of a binary clock tree 4 derived by performing the Steiner tree algorithm on the layout 3. The leaf node NA can correspond to the block A; the leaf node NB can correspond to the block B; the leaf node NC can correspond to the block C; and the source node NS can correspond to the source S.

Accordingly, the information of the source node NS and the leaf nodes NA to NC in the layout 3 are obtained to perform the Steiner tree algorithm to determine the information of a set of branch nodes. The set of branch nodes may include a first branch node S1 and a second branch node S2.

In some embodiments, two leaf nodes may be selected to generate a branch node. The information of the branch node may be determined by selecting a first node and a second node from N leaf nodes, the first node and the second node having a first minimum Manhattan distance, and then determining a position of the first branch node S1 according to a weight of the first node and a weight of the second node. For example, since the Manhattan distance between the leaf node NA and the leaf node NB is less than the Manhattan distance between the leaf node NB and the leaf node NC and the Manhattan distance between the leaf node NA and the leaf node NC, the Manhattan distance between the leaf node NA and the leaf node NB is determined as the first minimum Manhattan distance, and thus, the leaf node NA and the leaf node NB are selected from the leaf nodes NA to NC for generating the first branch node S1, and then a position of the first branch node S1 is determined according to the weight of the leaf node NA and the weight of the leaf node NB.

In some embodiments, the determination of the position of the first branch node S1 according to the weight of the leaf node NA and the weight of the leaf node NB comprises adjusting the position of the first branch node S1 until a first sum of the weight of the leaf node NA (=Da) and a weight of a connection between the first branch node S1 and the leaf node NA (=Pa) is equal to a second sum of the weight of the leaf node NB (=Db) and a weight of a connection between the first branch node S1 and the leaf node NB (=Pb). The first sum and/or the second sum may be referred to as the weight of the first branch node S1. The weight of the connection between two nodes may be the latency between the two nodes. For example, the weight Pa is the latency between the first branch node S1 and the leaf node NA, and the weight Pb is the latency between the first branch node S1 and the leaf node NB. If the weight Da of the leaf node NA exceeds the weight Db of the leaf node NB, the weight Pa of the connection between the first branch node S1 and the leaf node NA will be less than the weight Pb of the connection between the first branch node S1 and the leaf node NB. In this manner, the time a clock signal travelling from the first branch node S1 to the leaf node NA is equal to the time the clock signal travelling from the first branch node S1 to the leaf node NB. The leaf nodes NA and NB, and the first branch node S1 are connected together.

In some embodiments, one leaf node and one branch node may be selected to generate another branch node. The information of the other branch node may be determined by selecting a first branch node, selecting a third node from the remaining nodes other than the first node and the second node, the first branch node and the third node having a second minimum Manhattan distance, and then determining a position of the second branch node according to the first sum and a weight of the third node. The remaining nodes comprise all nodes other than the nodes having been selected (i.e., the remaining nodes comprise the leaf node NC and the first branch node S1). The Manhattan distance between the first branch node S1 and the leaf node NC may be the second minimum Manhattan distance, and may be equal to or different from the first minimum Manhattan distance. Thus, the first branch node S1 and the leaf node NC are selected to generate the second branch node S2, and then a position of the second branch node S2 is determined according to the weight of the first branch node S1 (i.e., the first sum) and the weight of the leaf node NC.

In some embodiments, the determination of the position of the second branch node S2 according to the first sum and the weight of the leaf node NC comprises adjusting the position of the second branch node S2 until a third sum of the first sum (=Da+Pa) and a weight of a connection between the second branch node S2 and the first branch node S1 (=pd) is equal to a fourth sum of the weight of the leaf node NC(=Dc) and a weight of a connection between the second branch node S2 and the leaf node NC(=Pc). The third sum and/or the fourth sum may be referred to as the weight of the second branch node S2. The weight Pd is the latency between the second branch node S2 and the first branch node S1, and the weight Pc is the latency between the second branch node S2 and the leaf node NC. In this manner, the time a clock signal travelling from the second branch node S2 to the leaf node NC is equal to the time the clock signal travelling from the second branch node S2 to the leaf node NA and the time the clock signal travelling from the second branch node S2 to the leaf node NB. The leaf nodes NA to NC, the first branch node S1, and the second branch node S2 are connected together.

Since the leaf nodes NA to NC and the set of branch nodes (S1, S2) are all connected together to form a binary tree, the source node NS is connected to the last branch node (S2) to complete the binary clock tree.

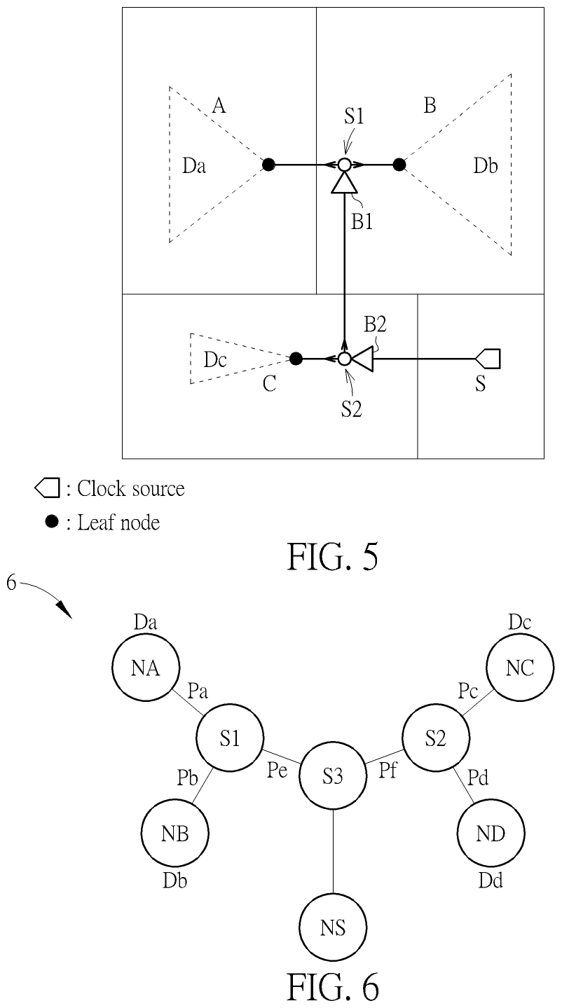

FIG. 5 shows layout diagram of a layout of the binary clock tree in FIG. 4. After performing the Steiner tree algorithm, the information of the branch nodes S1 and S2 are determined. An anchor buffer is placed at the position of each of the branch node. For example, in FIG. 5, anchor buffers B1 and B2 are placed at the positions of the branch nodes S1 and S2 respectively.

In Step 103, create a clock feedthrough according to the information of the source node, the information of the N leaf nodes, and the information of the set of branch nodes of the binary clock tree. For example, a clock feedthrough may be created between the position of the first branch node S1 to the position of the leaf node NA.

FIG. 6 shows a graph model of a binary clock tree 6 according to another embodiment of the present invention. In FIG. 6, the binary clock tree 6 comprises a source node NS, leaf nodes NA to ND, and branch nodes S1 to S3. The weight of the leaf node NA is Da, the weight of the leaf node NB is Db, the weight of the leaf node NC is Dc, and the weight of the leaf node ND is Dd.

After obtaining information of a source node the leaf nodes, perform the Steiner tree algorithm to determine information of a set of branch nodes. For example, in FIG. 6, since the leaf node NA and the leaf node NB have a first minimum Manhattan distance therebetween, select the leaf node NA and the leaf node NB from the leaf nodes NA to ND generate the branch node S1. Then determine a position of the branch node S1 according to the weight of the leaf node NA and the weight of the leaf node NB.

The determination of the position of the branch node S1 according to the weight of the leaf node NA and the weight of the leaf node NB comprises adjusting the position of the branch node S1 until a first sum (=Da+Pa) of a weight of the leaf node NA (=Da) and a weight of a connection between the branch node S1 and the leaf node NA (=Pa) is equal to a second sum (=Db+Pb) of a weight of the leaf node NB (=Db) and a weight of a connection between the branch node S1 and the leaf node NB (=Pb). The first sum and/or the second sum may be referred to as the weight of the branch node S1.

Then, since the leaf node NC and the leaf node ND have a second minimum Manhattan distance therebetween, select the leaf node Nc and the leaf node ND from the remaining nodes to generate the branch node S2, the remaining nodes comprising all nodes other than the nodes having been selected (i.e., the remaining nodes comprise the leaf nodes NC and ND and the branch node S1). The second minimum Manhattan distance may be equal to or different from the first minimum Manhattan distance. Then determine a position of the branch node S2 according to the weight of the leaf node NC and the weight of the leaf node ND.

The determination of the position of the branch node S2 according to the weight of the leaf node NC and the weight of the leaf node ND comprises adjusting the position of the branch node S2 until a third sum (=Dc+Pc) of the weight of the leaf node NC(=Dc) and a weight of a connection between the branch node S2 and the leaf node NC(=Pc) is equal to a fourth sum (=Dd+Pd) of the weight of the leaf node ND (=Dd) and a weight of a connection between the branch node S2 and the leaf node ND (=Pd). The third sum and/or the fourth sum may be referred to as the weight of the branch node S2.

In some embodiments, two branch nodes may be selected to generate another branch node. For example, select the branch nodes S1 and S2 from the remaining nodes, the remaining nodes comprising all nodes other than the nodes having been selected (i.e., the remaining nodes comprise the branch nodes S1 and S2). Create a branch node S3 according to the branch nodes S1 and S2 having a third minimum Manhattan distance. The third minimum Manhattan distance may be equal to or different from the first minimum Manhattan distance and the second minimum Manhattan distance. Then determine a position of the branch node S3 according to the weight of the branch node S1 (i.e., the first sum) and the weight of the branch node S2 (i.e., the third sum).

The determination of the position of the branch node S3 according to the weight of the branch node S1 and the weight of the branch node S2 comprises adjusting the position of the branch node S3 until a sum of the first sum (=Da+pa) and a weight of a connection between the branch node S3 and the branch node S1 (Pe) is equal to a sum of the third sum (=Dc+pc) and a weight of a connection between the branch node and the branch node (Pf).

Since the leaf nodes NA to ND and the set of branch nodes (S1 to S3) are all connected together to form a binary tree, the source node NS is connected to the last branch node S3 to complete the binary clock tree.

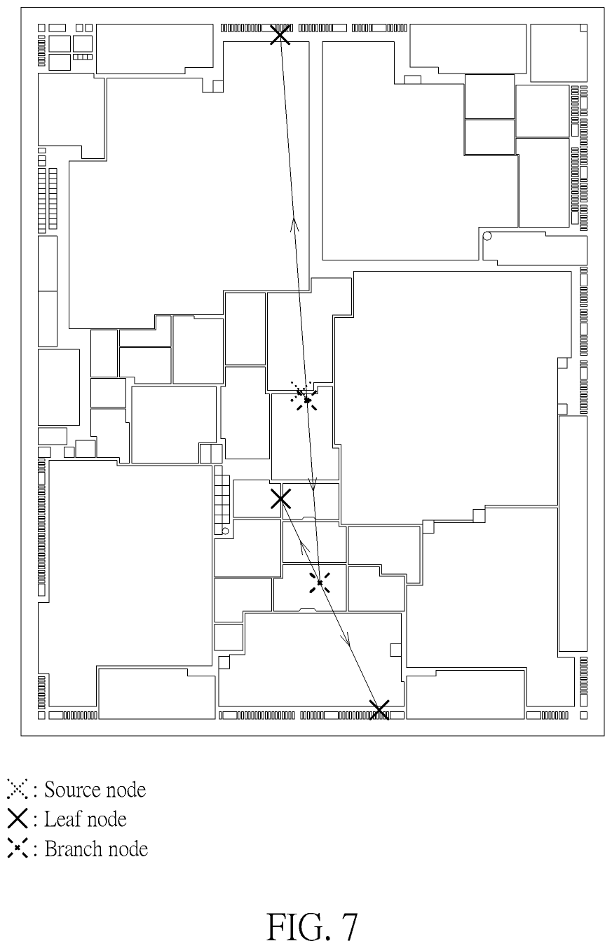

FIG. 7 shows layout diagram of a pre-balanced binary clock tree according to another embodiment of the present invention. A pre-balanced binary clock tree is the binary clock tree formed after performing Step S100 in clock tree synthesis method 1. In FIG. 7, the branch nodes are placed and the source node, the leaf nodes and the branch nodes are connected according to the pre-balanced binary clock tree. The connection in FIG. 7 is just a simulation after performed algorithm, not the actual clock path.

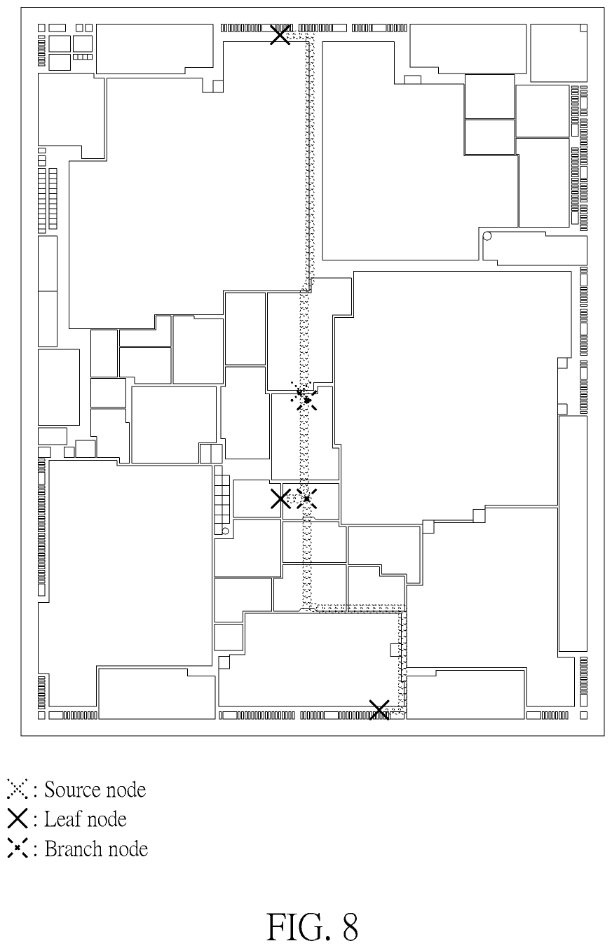

FIG. 8 shows layout diagram of a post-balanced binary clock tree according to the pre-balanced binary clock tree in FIG. 8. A post-balanced binary clock tree is the binary clock tree formed after performing Step S200 and Step S300 in clock tree synthesis method 1. After optimizing and evaluating the binary clock tree, plan the clock path according to the binary clock tree and the position of the partitions. In some embodiments, some of the partitions cannot be passed through and the clock path is arranged along the edge of the partitions.

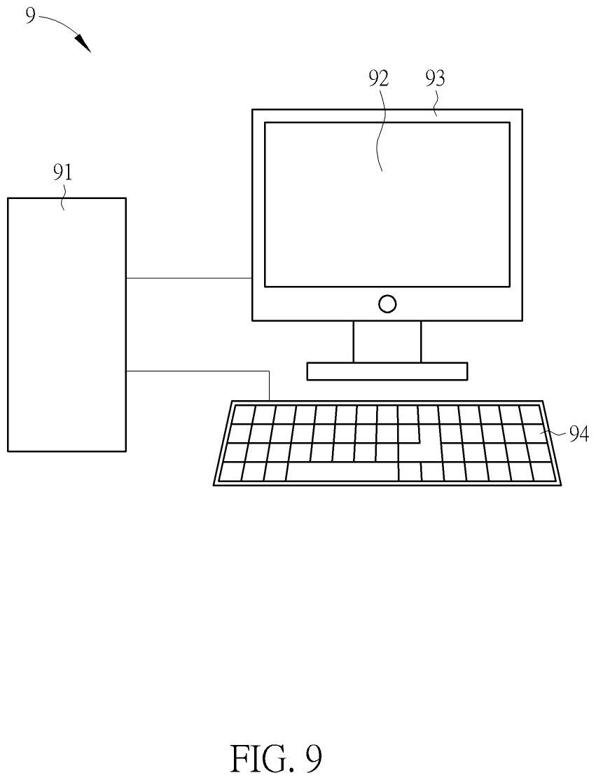

FIG. 9 shows a computer system for performing a clock tree synthesis method. The computer system 9 includes a central processing unit (CPU) 91, a display device 93, and an input device 94. The display device 93 and an input device 94 are connected to the central processing unit (CPU) 91. The CPU 91 may perform the clock tree synthesis method 1. In some embodiments, the CPU 91 may perform the Stenier tree algorithm to plan a binary clock tree. The binary clock tree can be displayed on a graphical user interface (GUI) 92 on the display device 93. Users can interact with the graphical user interface 92 and modify the binary clock tree manually using the input device 94. The input device 94 can be a mouse, a touch pad or a keyboard.

In the present invention, the clock tree synthesis method can plan a binary clock tree with balanced clock skew and low clock latency, thus reduce on-chip variation impact. The clock tree synthesis method can also create clock feedthrough according to the binary clock tree, thus saved the channels area and reduce the chip area.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A clock tree synthesis method comprising:
obtaining information of a source node and information of N leaf nodes, N being a positive integer greater than 1;
performing a Steiner tree algorithm according to the information of the source node and the information of the N leaf nodes to determine information of a set of branch nodes; and
creating a clock feedthrough according to the information of the source node, the information of the N leaf nodes, and the information of the set of branch nodes.

2. The method of claim 1, wherein:
the information of the source node comprises a position; and
information of a leaf node in the N leaf nodes comprises a position and a weight.

3. The method of claim 2, wherein performing the Steiner tree algorithm according to the information of the source node and the information of the N leaf nodes to determine the information of the set of branch nodes comprises:
selecting a first node and a second node from N leaf nodes, the first node and the second node having a first minimum Manhattan distance; and
determining a position of a first branch node according to a weight of the first node and a weight of the second node.

4. The method of claim 3, wherein determining the position of the first branch node according to the weight of the first node and the weight of the second node comprises
adjusting the position of the first branch node until a first sum of a weight of the first node and a weight of a connection between the first branch node and the first node is equal to a second sum of a weight of the second node and a weight of a connection between the first branch node and the second node.

5. The method of claim 4, wherein performing the Steiner tree algorithm according to the information of the source node and the information of the N leaf nodes to determine the information of the set of branch nodes further comprises:
selecting the first branch node and selecting a third node from remaining nodes other than the first node and the second node, the first branch node and the third node having a second minimum Manhattan distance; and
determining a position of a second branch node according to the first sum and a weight of the third node.

6. The method of claim 5, wherein determining the position of the second branch node according to the first sum and a weight of the third node comprises:
adjusting the position of the first branch node until a third sum of the first sum and a weight of a connection between the second branch node and the first branch node is equal to a fourth sum of a weight of the third node and a weight of a connection between the second branch node and the third node.

7. The method of claim 4, wherein performing the Steiner tree algorithm according to the information of the source node and the information of the N leaf nodes to determine the information of the set of branch nodes further comprises:
selecting a third node and a fourth node from remaining nodes other than the first node and the second node, the third node and the fourth node having a second minimum Manhattan distance; and
determining a position of a second branch node according to a weight of the third node and a weight of the fourth node.

8. The method of claim 7, wherein determining the position of the second branch node according to the weight of the third node and the weight of the fourth node comprises:
adjusting the position of the second branch node until a third sum of a weight of the third node and a weight of a connection between the second branch node and the third node is equal to a fourth sum of a weight of the fourth node and a weight of a connection between the second branch node and the fourth node.

9. The method of claim 8, wherein performing the Steiner tree algorithm according to the information of the source node and the information of the N leaf nodes to determine the information of the set of branch nodes further comprises:
creating a third branch node according to the first branch node and the second branch node having a third minimum Manhattan distance; and
determining a position of a third branch node according to the first sum and the third sum.

10. The method of claim 8, wherein determining the position of the third branch node according to the first sum and the third sum comprises:
adjusting the position of the third branch node until a sum of the first sum and a weight of a connection between the third branch node and the first branch node is equal to a sum of the third sum and a weight of a connection between the third branch node and the second branch node.

11. The method of claim 2, wherein the weight of the leaf node is clock latency of the leaf node.

12. The method of claim 1, further comprising:
connecting the source node to a last branch node after the N leaf nodes and the set of branch nodes are connected together to form a binary tree.

13. The method of claim 12, further comprising optimizing the binary clock tree after creating the clock feedthrough according to the nodes.

14. The method of claim 13, further comprising feeding back clock information of a block after optimizing the binary clock tree.

15. The method of claim 14, further comprising collecting clock information of each of the blocks.

16. The method of claim 15, further comprising checking a quality of the binary clock tree according to the collected clock information.

17. The method of claim 14, wherein the block is a partition, a standard cell or a macro.
